(19) United States
(12) Patent Application Publication
(10) Pub. No.: US 2026/0212636 A1
(43) Pub. Date: Jul. 23, 2026

(54) SYSTEM FOR IMPLEMENTING OBJECT DETECTION AND SEGMENTATION MODEL USING HEIGHT INFORMATION

(71) Applicant: MEISSA INC., Seoul (KR)

(72) Inventors: Jung Hoon SUNG, Seoul (KR); Hyun Sun Park, Seoul (KR); Yong Hyub Sakong, Seoul (KR); Yeo Wool Lee, Seoul (KR); Young Ju Lee, Seoul (KR); Won Yo Hwang, Seoul (KR); Wi Joo Hoang, Seoul (KR); Min Jeong Kim, Seoul (KR)

(73) Assignee: MEISSA INC., Seoul (KR)

(21) Appl. No.: 19/187,268

(22) Filed: Apr. 23, 2025

(30) Foreign Application Priority Data
Jan. 17, 2025 (KR) 10-2025-0007120

(51) Int. Cl. G06V 10/26; G06T 7/507; G06V 10/764; G06V 20/13; G06V 20/17; G06V 20/10

(52) U.S. Cl. CPC G06V 10/26; G06T 7/507; G06V 10/764; G06V 20/13; G06V 20/17; G06T 2207/10032; G06T 2207/20081; G06T 2207/30184; G06T 2207/30188; G06V 20/176; G06V 20/182; G06V 20/188

(57) ABSTRACT

Provided is a system for implementing an object detection and segmentation model using height information. The system includes an object segmentation module configured to accommodate orthophoto data acquired from a satellite and an aerial drone and then segment pixel-specific objects from the accommodated orthophoto data, a height estimation module configured to calculate a height value of each segmented object in a corresponding region on the basis of an estimated height value which is obtained using digital surface model (DSM) data or electro-optical (EO) satellite data of the corresponding region, and a final segmentation module configured to output object segmentation result values for final land cover data and final land use data by combining results acquired from the object segmentation module and the height estimation module.

### CROSS-REFERENCE TO RELATED APPLICATION

This application claims priority to and the benefit of Korean Patent Application No. 10-2025-0007120, filed on Jan 17, 2025, the disclosure of which is incorporated herein by reference in its entirety.

### BACKGROUND

### Field of the Invention

The present invention relates to a system for implementing an object detection and segmentation model, and more particularly, to a system for implementing an object detection and segmentation model using height information that can remarkably improve the accuracy of a semantic segmentation model by applying object-specific type and height information to an orthophoto.

### Discussion of Related Art

Object detection and segmentation technologies utilizing orthophoto data acquired from a satellite image or an aerial drone are essentially being used in a variety of industrial fields. In particular, the technology for classifying objects on the basis of orthophotos and visualizing the objects in three dimensions is becoming increasingly important in urban planning, land use analysis, disaster countermeasures, and the like. However, existing technologies have a number of limitations in handling this data.

The first problem with using only orthophoto data in an object detection and segmentation process is that the height information of objects is not included. The height of an object is an important factor in distinguishing and classifying surface objects such as buildings, roads, and vegetation, but existing technologies do not explicitly utilize this information, which may lead to blurred distinctions between objects. This may significantly degrade the accuracy of classification, especially when it is necessary to distinguish between objects that are similar in appearance such as buildings and vegetation.

Also, existing technologies essentially require digital surface model (DSM) data in many cases. However, DSM data is not available in all regions, and even when there is available DSM data, the data is often out of date. When DSM data of a region is not present or outdated, the accuracy of object detection and segmentation for the region is significantly lowered, which reduces the reliability of a three-dimensional (3D) map as a result.

Algorithms for processing orthophoto data are also a problem with existing technologies. Most object detection and segmentation technologies employ simple, pixel-based classification methods that do not fully account for complex interactions and spatial relationships between objects. This limitation may lead to failures to accurately detect and segment multiple objects simultaneously in complex urban environments or natural regions.

In addition, existing technologies tend to rely on rules predefined by a user or limited training data in an object classification process. For this reason, existing technologies cannot flexibly handle new environments or data including atypical objects, and object detection results are often distorted or unreliable.

Further, even when utilizing object height information, most existing technologies handle the information as secondary information and do not use the information as a primary criterion for object segmentation. Although height information is important data for clearly identifying the structural features of an object, existing algorithms do not incorporate height information effectively, limiting its value.

Moreover, existing technologies lack the function of learning or correcting errors in an object detection and segmentation process in real time. For example, when height information or object segmentation results are incomplete, a process of improving the results by feeding the results back into the training data is insufficient or absent, and thus there is a high probability that the same type of error will occur again and again.

A problem also arises with application technologies utilizing the results of object detection and segmentation. Existing technologies focus on simply visualizing and storing the results of object segmentation, which limits the utilization range of data. In particular, there is a lack of structural support for further combining rule-based learning or deep learning models to continuously improve the accuracy of results.

Lastly, existing technologies cannot effectively handle the fusion of different data sources in an object detection and segmentation process. For example, despite the possibility of utilizing satellite data and reconnaissance satellite data in combination, most technologies rely on a specific data type, making the system less flexible and scalable.

As described above, existing technologies cannot effectively utilize height information which is an important factor in object detection and segmentation, and cannot solve problems caused by inaccuracy or a lack of data. The present invention in intended to address these issues and focuses on improving the accuracy of object detection and segmentation by utilizing orthophoto data and DSM data in an integrative manner, and enhancing the flexibility and scalability of a system.

### RELATED ART DOCUMENTS

### Patent Documents

:Patent Document 1: Korean Patent No. 10-1061547 (filed on August 26, 2011)

### SUMMARY OF THE INVENTION

The present invention is directed to providing a system for implementing an object detection and segmentation model that can solve a problem of the related art that, when there is no digital surface model (DSM) for a region, it is not possible to build a three-dimensional (3D) map of the region, can give a height-related feature to each object using a DSM after accurately classifying each object constituting the region, and can improve the accuracy of classification by explicitly utilizing the height of each object based on DSM data.

According to an aspect of the present invention, there is provided a system for implementing an object detection and segmentation model, the system including an object segmentation module configured to accommodate orthophoto data acquired from a satellite and an aerial drone and then segment pixel-specific objects from the accommodated orthophoto data, a height estimation module configured to calculate a height value of each segmented object in a corresponding region on the basis of an estimated height value which is obtained using DSM data or electro-optical (EO) satellite data of the corresponding region, and a final segmentation module configured to output object segmentation result values for final land cover data and final land use data by combining results acquired from the object segmentation module and the height estimation module.

The object segmentation module may include a raw data accommodation part configured to extract orthophoto data acquired from a satellite and an aerial drone regarding the corresponding region designated by a user from an Internet network or a prestored database and store the extracted orthophoto data in a database installed in the system, a pixel segmentation part configured to classify each pixel as an object in the orthophoto data extracted by the raw data accommodation part and partition an area of each object from an entire area, and an object-type classification part configured to classify an object of each area partitioned by the pixel segmentation part as a road object, a building object, or a vegetation object.

The height estimation module may include a height estimation part configured to estimate a height of each object using the EO satellite data of the corresponding region and give an estimated corresponding height to each object when there is no DSM data of the region designated by the user, a parallel output part configured to estimate a height of each object using the EO satellite data of the corresponding region and give an estimated corresponding height to each object together with old-version data when the DSM data of the corresponding region designated by the user is the old-version data falling outside a preset tolerance period, and an information utilization part configured to give a corresponding height to each object using the DSM data of the corresponding region when the DSM data of the corresponding region designated by the user is data falling within the preset tolerance period.

The final segmentation module may include an object segmentation result derivation part configured to output object segmentation results for final land cover data and final land use data by combining results of the object segmentation module and results of the height estimation module and a final object-type output part configured to determine whether a height value given in accordance with an object type satisfies a preset criterion, output a final object type of a corresponding object when the height value given in accordance with the object type satisfies the preset criterion, and give a height value to the corresponding object again through the height estimation module and then output a final object type for the corresponding object when the height value given in accordance with the object type does not satisfy the preset criterion.

The final segmentation module may include an additional training part configured to perform rule-based learning on the basis of data acquired through the object segmentation result derivation part and the final object-type output part, or add a deep learning model layer, perform training, and then store training results in the database installed in the system.

### BRIEF DESCRIPTION OF THE DRAWINGS

The above matters and other objects, features, and advantages of the present invention will become more apparent to those of ordinary skill in the art by describing exemplary embodiments thereof in detail with reference to the accompanying drawings, in which:

FIG. 1 is a block diagram of a system for implementing an object detection and segmentation model according to an exemplary embodiment of the present invention;

FIG. 2 is a diagram of objects that are classified pixel by pixel in orthophoto data and classified as road objects, building objects, and vegetation objects through an object segmentation module of the system for implementing an object detection and segmentation model according to the exemplary embodiment of the present invention;

FIG. 3 is a photograph showing digital surface model (DSM) data utilized by a height estimation module of the system for implementing an object detection and segmentation model according to the exemplary embodiment of the present invention;

FIG. 4 is a set of photographs showing electro-optical (EO) satellite data utilized by the height estimation module of the system for implementing an object detection and segmentation model according to the exemplary embodiment of the present invention; and

FIG. 5 is a diagram showing a screen output through a final segmentation module of the system for implementing an object detection and segmentation model according to the exemplary embodiment of the present invention.

### DETAILED DESCRIPTION OF EXEMPLARY EMBODIMENTS

Hereinafter, exemplary embodiments of the present invention will be described in detail. It should be noted that terms and words used in this specification and claims are not to be construed in their ordinary or dictionary sense, but rather in a sense and concept consistent with the technical idea of the present invention.

Throughout the specification, when a member is referred to as being “on” another member, the member may be in contact with the other member, or still another member may also exist between the two members. In addition, when a part is referred to as “including” a component, this implies the inclusion of other components rather than the exclusion of any other components unless particularly described otherwise.

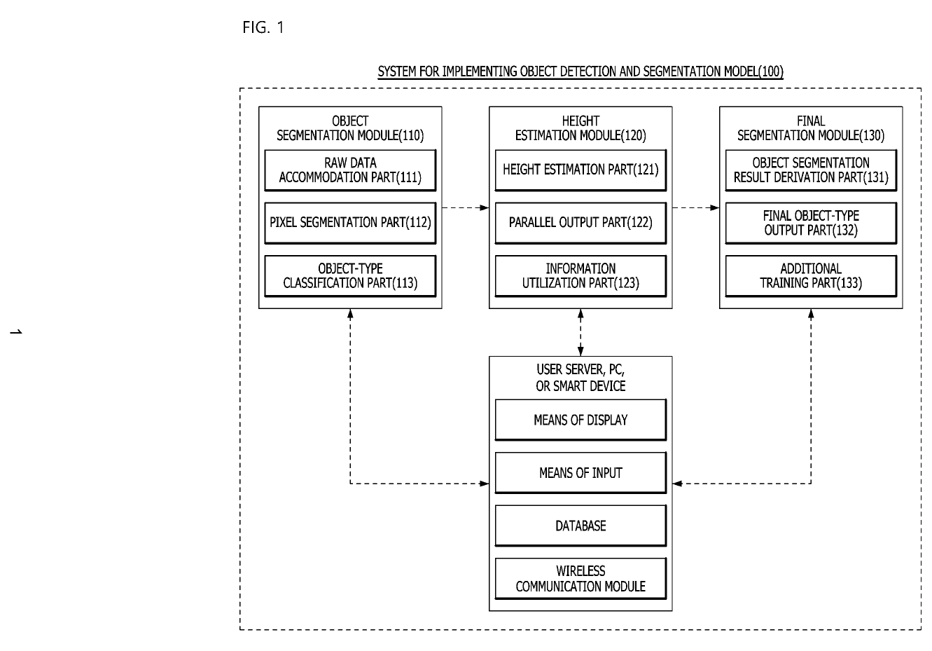

FIG. 1 is a block diagram of a system for implementing an object detection and segmentation model according to an exemplary embodiment of the present invention.

Referring to FIG. 1, a system 100 for implementing an object detection and segmentation model according to this exemplary embodiment of the present invention includes an object segmentation module 110, a height estimation module 120, and a final segmentation module 130 that perform specific roles. Accordingly, when building a three-dimensional (3D) map on the basis of orthophoto data acquired from a satellite and an aerial drone, the system 100 for implementing an object detection and segmentation model can solve a problem of the related art that, when there is no digital surface model (DSM) for a region, it is not possible to build a 3D map of the region, can give a height-related feature to each object using a DSM after accurately classifying each object constituting the region, and can improve the accuracy of classification by explicitly utilizing the height of each object based on DSM data.

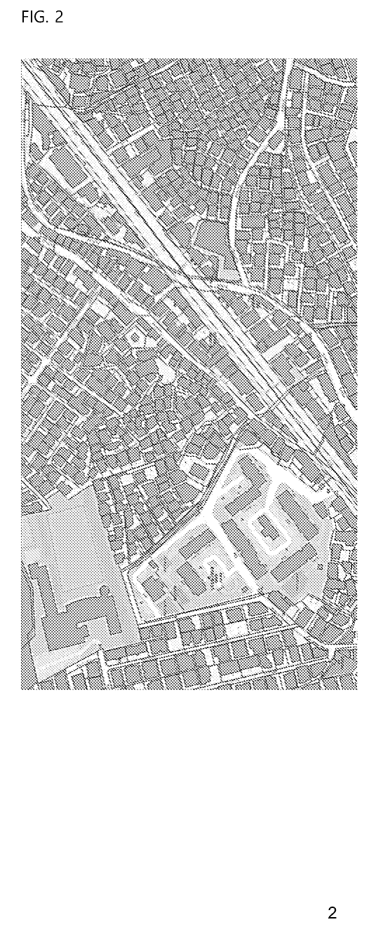

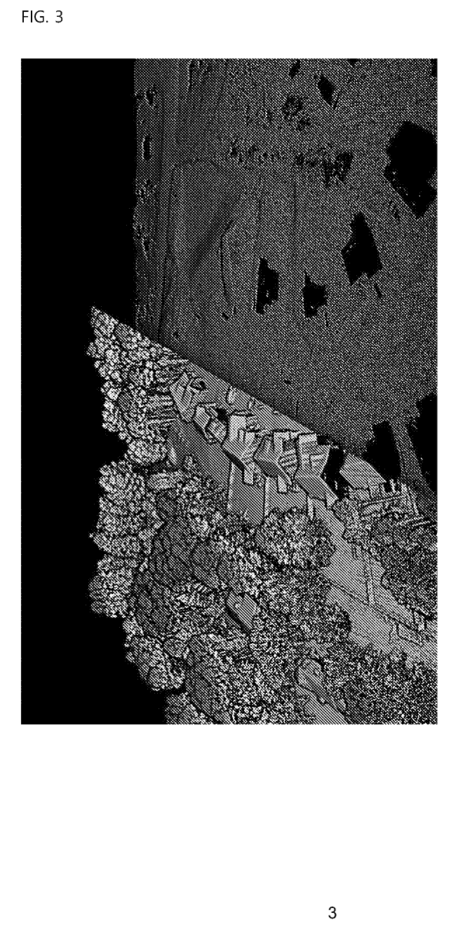

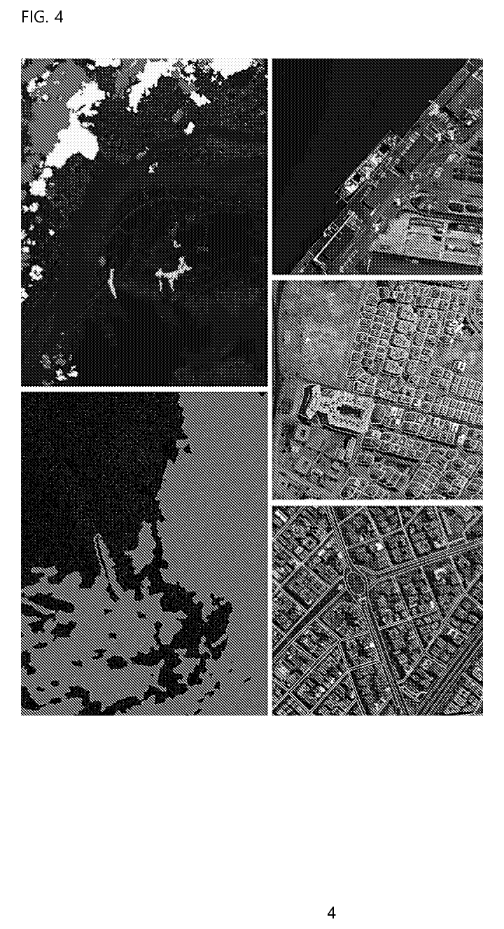

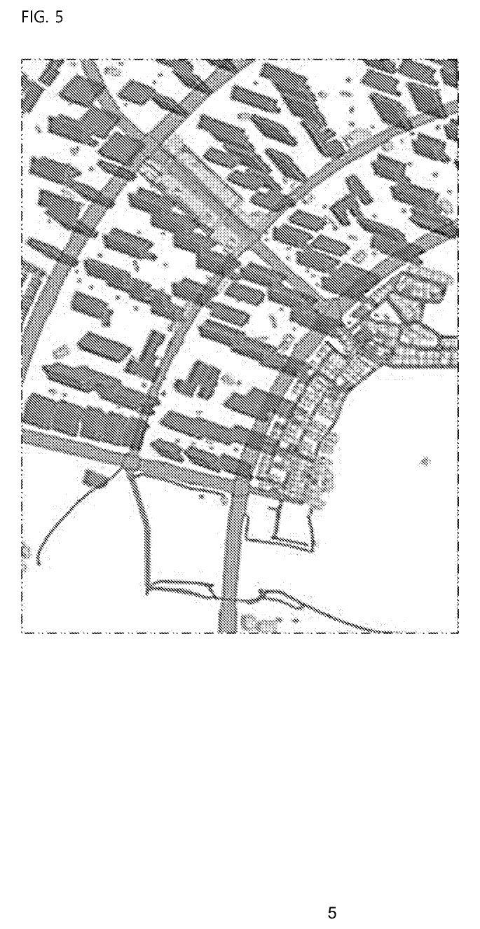

Each element of the system 100 for implementing an object detection and segmentation model according to the exemplary embodiment will be described in detail below with reference to FIGS. 1 to 5.

### Detailed Configuration and Role of Bbject Segmentation Module 110

The object segmentation module 110 performs a core function of segmenting pixel-specific objects by processing orthophoto data acquired from a satellite and an aerial drone. This module has been designed to efficiently analyze an orthophoto and accurately distinguish between objects. Orthophoto data often covers a large region, and unclear definition of the boundaries between objects may degrade the reliability of analysis. To address this, the object segmentation module 110 segments objects with high accuracy using a high-performance segmentation algorithm.

While processing data, the object segmentation module 110 considers spatial features and color information together. For example, a building and a road may have different colors or textures, but their boundary may not be clear. This module analyzes the continuity between pixels using a boundary estimation technique and separates objects on the basis of the analysis. This approach ensures high segmentation accuracy even in complex urban environments.

Also, the object segmentation module 110 analyzes attributes of each pixel using a machine learning technique. For example, when orthophoto data of a specific region is input, this module classifies objects, such as roads, buildings, vegetation, and the like, and gives a tag to each pixel through the trained model. This allows the system 100 to generate sophisticated segmentation results that reflect interactions between objects.

The object segmentation module 110 has another characteristic that real-time data processing is possible. For example, the object segmentation module 110 may analyze data acquired in real time by a drone and immediately provide information required for an emergency rescue operation (e.g., the locations of obstacles and accessible roads). This saves time and provides work efficiency in emergency situations.

Lastly, the object segmentation module 110 interacts with other modules to perform integrated data analysis. For example, the object segmentation module 110 may additionally analyze height information of each object in conjunction with the height estimation module 120 and generate more accurate object segmentation results on the basis of the analysis. This integrated approach greatly increases the possibility of utilization in various industrial fields.

### Raw Data Accommodation Part 111

The raw data accommodation part 111 functions to efficiently store and manage orthophoto data acquired from a satellite and an aerial drone. This accommodation part has been designed to collect data through the Internet or extract related data from a previously stored database. For example, when orthophoto data of a huge urban region is input into the raw data accommodation part 111, the corresponding data is systematically organized for use in a follow-up processing operation.

The raw data accommodation part 111 may process various forms of orthophoto data. For example, the raw data accommodation part 111 supports JPEG, TIFF, or other image formats and converts data into a standard format as necessary. This provides flexibility in a data input process and allows accommodation of various data sources.

The raw data accommodation part 111 also has a function of verifying the quality of data. For example, when data input by a user has a too low resolution or is damaged, the accommodation part identifies this and provides a warning to the user. In this way, it is possible to remove in advance factors that may degrade the accuracy of data analysis.

The raw data accommodation part 111 also provides a metadata management function to efficiently segment and organize data. For example, the raw data accommodation part 111 stores information, such as coordinates, an imaging time, a resolution, and the like of a specific region, as metadata to speed up data retrieval and processing. This is particularly useful when dealing with a large dataset.

Finally, the raw data accommodation part 111 serves to transmit the collected data to the object segmentation module or other modules. In this process, the raw data accommodation part 111 maintains data integrity such that the data is not distorted, and optimizes a data transmission rate. This function significantly improves the performance and efficiency of the overall system.

### Pixel Segmentation Part 112

The pixel segmentation part 112 serves to analyze each pixel in the orthophoto data collected by the raw data accommodation part 111 and segment objects. This segmentation part identifies the boundaries between objects in consideration of attributes such as the color, the texture, the spatial location, and the like of each pixel. For example, the walls and roof of a building are classified as the same building object but are analyzed pixel by pixel to clearly define their boundaries.

The pixel segmentation part 112 performs a pixel segmentation task using various algorithms. For example, a deep learning model, such as U-Net or a fully convolutional network (FCN), is used to estimate object attributes of each pixel. These algorithms analyze correlations between pixels on the basis of learned data and generate object segmentation results with high accuracy.

The pixel segmentation part 112 may efficiently operate even in a complex environment. For example, in the case of an urban region, the boundaries between roads and buildings may be unclear. This segmentation part analyzes spatial context to solve this problem. This improves the reliability of object segmentation and increases the possibility of actual application.

In addition, the pixel segmentation part 112 may adjust segmentation results in consideration of the sizes and shapes of objects. For example, roads generally have a long and continuous shape, and buildings have rectangular shapes of a certain size. Accuracy is further improved by reflecting these features and correcting segmentation results.

Lastly, the pixel segmentation part 112 transmits segmented pixel data to the object-type classification part 113. This data is prepared to classify attributes of each object and to be utilized in a follow-up analysis operation. This process is a core part of the overall object detection and segmentation system and enables accurate data analysis.

### Pixel-Specific Object Classification and Area Segmentation Method of Pixel Segmentation Part 112

The pixel segmentation part 112 plays a key role of analyzing each pixel of the orthophoto data to classify objects and partitioning areas of the objects. This process enables accurate and precise classification and segmentation using visual and spatial features of objects. For example, it is possible to separate objects, such as roads, buildings, vegetation, and the like, in pixel units in an orthophoto of an urban region.

The first operation is pixel feature extraction. The pixel segmentation part 112 extracts features, such as a color, texture, brightness, spatial location, and the like, from each pixel of the orthophoto data. For example, building pixels generally are bright and have straight texture, and vegetation pixels have greenish colors and irregular textures. These features are utilized as basic data for classifying objects.

The second operation is application of an object classification algorithm. The pixel segmentation part 112 uses a deep learning model or an existing classification algorithm to analyze attributes of each pixel and classify objects. For example, a deep learning model, such as U-Net, analyzes context information around pixels to classify objects such as a building, a road, vegetation, and the like. This approach provides high accuracy and works effectively even in a complex environment.

As the third operation, area segmentation is performed in consideration of correlations between pixels. The pixel segmentation part 112 analyzes spatial relationships between adjacent pixels to define the boundaries of objects. For example, road objects have continuous and linear shapes, and thus an entire area is defined by connecting adjacent road pixels. This is useful for reducing classification errors that may occur in precise pixel-unit analysis.

As the fourth operation, object boundaries are adjusted in detail. The pixel segmentation part 112 corrects irregularities that may occur at the boundaries of objects, to generate clear boundaries. For example, in areas where the boundaries of building objects and road objects overlap, color and texture information is additionally analyzed to adjust the boundaries. This process reduces confusion between objects and improves classification accuracy.

As the fifth operation, homogeneity within objects is checked, and segmentation corrections are made. The pixel segmentation part 112 determines whether pixels inside each object have the same attributes, and when there is an outlier, corrects the outlier. For example, when there is a road pixel which has been incorrectly classified inside a building object, the road pixel may be removed or adjusted in accordance with attributes of surrounding pixels. This is important for maintaining consistency in object segmentation.

As the sixth operation, object classification results are visualized. The pixel segmentation part 112 visually expresses segmented objects such that the user may easily identify the objects. For example, a segmentation result image with buildings in blue, roads in red, and vegetation in green is generated. This visualization is useful for interpreting results and making corrections as necessary.

Lastly, segmentation results are stored in a database. The pixel segmentation part 112 structures and stores segmented object data in the database to utilize the stored data in analysis or training thereafter. For example, the stored data may be used by an additional training part 133 as input data for rule-based training or deep learning model training. This storage process increases the reusability of data and enhances the scalability of the system.

Through this process of the pixel segmentation part 112, high-quality data that can be utilized in various application fields is generated by accurately classifying objects on the basis of orthophoto data and precisely segmenting the area of each object. This process is a basic operation of data analysis and contributes to a significant improvement in the performance of the entire system.

### Object-Type Classification Part 113

The object-type classification part 113 serves to classify each object as a road, a building, vegetation, or the like on the basis of the data received from the pixel segmentation part 112. This classification part analyzes attributes of each object to identify an appropriate object type. For example, roads have a continuous and flat structure, and buildings have certain heights and rectangular shapes. Objects are classified on the basis of these features.

The object-type classification part 113 increases classification accuracy by utilizing various data sources. For example, additional DSM data or height data is used to distinguish between buildings and vegetation. Such fusion of data significantly improves the reliability of classification results.

The object-type classification part 113 may detect a new type of object by utilizing a learning-based model. For example, when there is a new building structure or a new road type in data that has not been learned, this classification part updates a learning algorithm to maintain classification accuracy.

The object-type classification part 113 also has a function of visually providing classification results. For example, the object-type classification part 113 gives a unique color to each object to help the user to easily understand object classification results. This makes a data analysis process more intuitive.

Lastly, the object-type classification part 113 functions to store classified data or transmit the classified data to another module. This data is utilized in a follow-up analysis operation and contributes finally to an improvement in the overall performance of the system for implementing an object detection and segmentation model.

### Method of Classifying Each Object by Object-Type Classification Part 113

The object classification part 113 serves to classify objects into types of road, building, vegetation, and the like, on the basis of the received data. In this process, visual, spatial, and data-based features of objects are analyzed to provide classification results with high accuracy. For example, buildings, roads, and parks in an urban region may be classified as different objects.

In the first operation, visual features of objects are analyzed. The object-type classification part 113 analyzes visual attributes, such as colors, textures, brightness, and the like, of objects to identify basic object types. For example, roads generally have a uniform color and flat texture, buildings have bright and straight boundaries, and vegetation has irregular textures with greenish colors. These visual features provide important clues for classifying objects.

In the second operation, classification is performed by utilizing height information. The object-type classification part 113 classifies objects by utilizing data provided by the height estimation module 120. For example, objects with a height of 10 meters or more are classified as buildings, and objects with a lower height are classified as roads or vegetation. Height information is very useful for classifying objects that are similar in appearance.

In the third operation, spatial locations and contexts of objects are analyzed. The object-type classification part 113 refines classifications by considering the locations of objects and relationships with nearby objects. For example, in many cases, roads are adjacent to building or park objects, and these spatial relationships may be analyzed to determine the types of objects more accurately.

In the fourth operation, a machine-learning-based classification model is applied. The object-type classification part 113 classifies objects using a pretrained machine learning model. For example, a deep-learning-based classification model receives pixel data and estimates a type of object. Such a model generates a result with high accuracy even in a complex environment by utilizing patterns which have been learned from various data.

In the fifth operation, classifications are complemented on the basis of rules. The object-type classification part 113 complements or verifies machine-learning results on the basis of specific rules. For example, misclassified pixels may be corrected on the basis of the rule “road objects have a flat and continuous shape and do not deviate from a certain color range.” This complementary task contributes to an improvement in the reliability of classification results.

In the sixth operation, results are verified, and outliers are removed. The object-type classification part 113 examines the classification results to identify and correct incorrect classifications. For example, when a pixel classified as a road object is isolated or there is a vegetation object that has been incorrectly classified in a building, the pixel or vegetation object may be removed or classified again. This verification process improves the quality of final classification results.

Lastly, the classification results are visualized and stored. The object-type classification part 113 visually expresses the classification results such that the user may easily check the classification results. For example, a result image with roads in red, buildings in blue, and vegetation in green is generated. The classification results are stored in the database and reutilized in a subsequent analysis or training process.

According to this classification method of the object-type classification part 113, various data and algorithms are combined to provide accurate and reliable object classification results. This process plays an important role in various application fields such as urban planning, disaster management, environmental analysis, and the like.

### Detailed Configuration and Role of Height Estimation Module 120

The height estimation module 120 is a key component that estimates the heights of objects by utilizing the orthophoto data and DSM data and incorporates the heights into object segmentation results. Even when there is no DSM data or DSM data is old, this module solves this problem by estimating heights from electro-optical (EO) satellite data. For example, when there is no DSM data for estimating building heights in a specific region, this module may estimate the heights of buildings by utilizing shadow lengths and sun angles in an orthophoto. An EO satellite is a satellite with EO equipment and generally a satellite for acquiring red green blue (RGB) images.

The height estimation module 120 enables clear distinctions between objects by calculating detailed height information of each object. For example, even when it is difficult to distinguish between buildings or trees with the same color or texture, this module can clearly separate two objects on the basis of their heights. This contributes to a significant improvement in the accuracy of object detection and segmentation.

The height estimation module 120 fuses various data sources to calculate an accurate height value. For example, the height estimation module 120 combines orthophoto data with EO satellite data to generate height information with reliability. This approach solves the problem of data sparsity in different environmental conditions and provides flexibility in object detection and segmentation.

The height estimation module 120 may reflect changes in data over time. For example, when the DSM data of a specific region is out of date, the height estimation module 120 provides the latest data by calculating updated height values using reconnaissance satellite data. This function plays an important role in constantly changing urban environments or natural environments.

Lastly, the height estimation module 120 operates in close coordination with the object segmentation module 110. Object-specific area information derived by the object segmentation module 110 is utilized to calculate height values in the height estimation module 120, and the generated height information is transmitted to the final segmentation module 130 to provide more precise object detection and segmentation results.

### Height Estimation Part 121

When there is no DSM data of a specific region, the height estimation part 121 serves to estimate the height of each object by utilizing the EO satellite data. This element has been designed to generate reliable data even when there is no DSM data. For example, the height estimation part 121 employs a method of estimating the height of a building by analyzing a shadow length and a sun angle in an orthophoto.

The height estimation part 121 maintains the precision of an entire dataset on the basis of heights estimated per object. For example, objects such as roads, buildings, and vegetation have different height features, and this element analyzes such features to estimate height values and incorporates the estimated height values into data. In this way, it is possible to improve the accuracy of segmentation results.

The height estimation part 121 improves the precision of estimations by utilizing a deep-learning algorithm. For example, the height estimation part 121 provides a function of estimating the height of a new object on the basis of past training data, and maintains high accuracy even in various environments. This function works stably even in a region with limited data sources.

The height estimation part 121 also provides a real-time data processing function. For example, the height estimation part 121 may estimate heights by analyzing orthophotos collected in real time by a drone, and immediately utilize the heights in a rescue operation or a disaster situation. This plays an important role in an emergency situation that requires rapid decision making.

Lastly, the height estimation part 121 transmits the estimated height values to the object segmentation module 110 and the final segmentation module 130 to complete data flow of the overall system. This data transmission process enhances interactions between modules and increases the reliability of an object detection and segmentation task.

### Object Height Estimation Method of Height Estimation Part 121

When there is no DSM data, the height estimation part 121 serves to estimate object-specific heights by utilizing the orthophoto and the EO satellite data. This process has been designed to estimate a height on the basis of features of an object and data and incorporate the height into an object segmentation result. For example, a building height may be estimated by analyzing the shadow length of the building in an urban region.

In the first operation, orthophoto data is utilized for shadow analysis. The height estimation part 121 detects shadows of objects, such as buildings, trees, and the like, in the orthophoto and calculates heights using the lengths of the shadows and a sun angle. For example, when the length of a shadow in an orthophoto captured at a specific time is 20 meters and a sun angle is 45 degrees, the height of a corresponding object may be calculated to be 20 meters using triangulation.

In the second operation, a DSM data substitution model is utilized. When DSM data is not present or is not up to date, the height estimation part 121 estimates the altitudes of objects using the EO satellite data. For example, the height estimation part 121 may calculate the surface reflectance of an object and the average height of surrounding regions on the basis of reconnaissance satellite data and estimate a relative height of the object such as a building or a tree.

The third operation is multi-image analysis. The height estimation part 121 reconfigures the 3D structures of objects by utilizing several images captured at different angles and estimates the heights of the objects. For example, image data of a building that is acquired at various angles by a drone may be input to calculate the actual height of the object. This technique is useful for precise height calculation.

The fourth operation is estimation employing a pretrained model. A deep-learning-based model learns the height of a specific type of object from data learned in the past, and estimates the height of a new object on the basis of the height. For example, the heights of objects in a new region may be estimated on the basis of average height information of roads, buildings, and vegetation learned from existing data.

The fifth operation is estimation employing correlations between objects. The height estimation part 121 analyzes spatial relationships between objects to estimate heights. For example, when a building is adjacent to a road, the height of the road may be estimated on the basis of the rule that roads are lower than buildings and are usually flat. Utilizing these correlations can increase the reliability of classification results.

In the sixth operation, corrections are made by utilizing terrain features. The height estimation part 121 corrects object heights by referring to terrain data for a specific region. For example, in a mountainous region, buildings of the same height may appear at different heights depending on the slope of the ground. Estimation values are adjusted to reflect such terrain features.

Lastly, there is a height verification and data integration process. The height estimation part 121 verifies accuracy by comparing the estimated heights with existing data. For example, when a height estimated from the orthophoto data is not the same as past DSM data of the same region, the height estimation part 121 calculates a final height value by correcting the estimated height or merging the estimated height with the past DSM data. This verification process ensures the reliability of final results.

The height estimation process of the height estimation part 121 employs various data sources and algorithms to provide reliable height information. This process plays an important role in increasing the accuracy of object detection and segmentation and is useful in various application fields.

### Parallel Output Part 122

When the DSM data is old, the parallel output part 122 functions to estimate heights using the EO satellite data in parallel with the existing old-version DSM data. This element utilizes old data and the latest data together to ensure the reliability of analysis. For example, when the old-version DSM data is more than five years old, this element utilizes reconnaissance satellite data to estimate updated height values and combines the estimated height values with the old-version DSM data.

The parallel output part 122 comparatively analyzes old-version data with new data to increase the precision of data. For example, when building heights of a specific region change over time, this element combines old-version DSM data with reconnaissance satellite data to calculate accurate height values. This is useful for urbanized regions or natural regions with many changes.

The parallel output part 122 performs a correction task to maintain the reliability of data. For example, when discrepancies are detected between old-version data and estimated data, the parallel output part 122 corrects the discrepancies and finally provides reliable data. This function contributes to minimizing data errors and increasing the reliability of results.

The parallel output part 122 provides high efficiency in a data integration task. For example, the parallel output part 122 processes data by combining the orthophoto data with reconnaissance satellite data in real time, simultaneously increasing the speed and accuracy of the object detection and segmentation task. This approach works stably even in the case of processing a large dataset.

Lastly, the parallel output part 122 transmits integrated data to the final segmentation module 130, and the integrated data is used to generate final results. This data includes accurate height information of each object and plays an important role in ensuring the reliability of the final results.

### Method of Giving Estimated Height and Old-Version Data Together by Parallel Output Part 122

When there is no latest DSM data of a specific region, the parallel output part 122 functions to calculate estimated height values on the basis of the EO satellite data and also give the old-version DSM data to objects together with the estimated height values. This approach is useful for increasing the reliability of analysis results when there is insufficient data or data has low accuracy.

In the first operation, old-version DSM data and reconnaissance satellite data are processed in advance. The parallel output part 122 evaluates the accuracy and reliability of the old-version DSM data. For example, the parallel output part 122 analyzes the year of generation, data accuracy, and regional applicability of corresponding data to determine the possibility of the data being utilized. Also, the reconnaissance satellite data is processed to estimate new height values.

In the second operation, the estimated height values are compared with the old-version DSM data and adjusted. The parallel output part 122 compares the old-version DSM data with the height values calculated on the basis of the reconnaissance satellite data to analyze differences between the two pieces of data. For example, when the old-version DSM data indicates that a building height is 50 meters, and a height calculated from the reconnaissance data is 55 meters, the two pieces of data may be combined as the average height (52.5 meters), or one of the two values may be prioritized in accordance with a specific criterion.

In the third operation, a reliability weight is applied to each object. The parallel output part 122 gives reliability weights to the old-version DSM data and the estimated height values to calculate final heights. For example, when the old-version DSM data is 10 years old or more, the reliability is set to 30%, and the reliability of the height values estimated from the reconnaissance data is set to 70% to calculate final heights. This weight application is effective in reducing errors that may be caused by a data merger.

In the fourth operation, the estimated heights are merged with the old-version data to give heights to objects. The parallel output part 122 gives a final height which is calculated per object to the object. For example, a height is set for each of road, building, and vegetation objects on the basis of the merged data. Since the height values of building objects have few changes, the old-version DSM data is applied first. On the other hand, vegetation objects are highly likely to change and thus reflect the reconnaissance satellite data more.

In the fifth operation, the results of giving object-specific heights are verified. The parallel output part 122 determines whether the given height values correspond to attributes of objects. For example, when a height given to a road object is excessively high or low, the height may be analyzed again and corrected. This verification process contributes to improving the reliability of final results.

In the sixth operation, the results of giving heights are visualized and provided to the user. The parallel output part 122 generates 3D visualization data on the basis of the merged height values and provides the 3D visualization data to the user. For example, the merged height values of building objects may be displayed as 3D models on a map, and the reliability information of each object may be provided together. This helps the user to intuitively check the quality of data.

Lastly, the results of giving heights are stored in the database. The parallel output part 122 stores the merged height data on an object-by-object basis such that the merged height data may be utilized for follow-up analysis or training. For example, the merged data may be utilized as training data for a deep learning model or reference data for analyzing another region. This data storage is useful for long-term data management and utilization.

According to this method of the parallel output part 122, limitations of the old-version DSM data are overcome, reconnaissance satellite data is utilized to complement insufficient data, and finally highly reliable object height data may be provided. This plays an important role in maintaining the quality of data in various application fields and ensuring the reliability of analysis results.

### Information Utilization Part 123

The information utilization part 123 serves to give a height to each object using corresponding DSM data when the DSM data is the latest data. This element analyzes reliable latest DSM data and incorporates the latest DSM data into an object detection and segmentation task to maximize accuracy. For example, recently updated DSM data of an urban region may be utilized to accurately assign height information to buildings and roads.

The information utilization part 123 provides a data preprocessing function to efficiently process DSM data. For example, the information utilization part 123 removes outliers from the DSM data or converts data into a standard format to minimize errors that may occur in an analysis process. This function has an important role in ensuring the quality of data.

The information utilization part 123 utilizes a rapid and efficient algorithm to analyze object-specific heights and incorporate the heights into data. For example, in the case of a building object, the height of each floor is calculated to produce the overall building height, and in the case of a road object, a difference in altitude between the road object and the ground surface is analyzed to provide an accurate height value.

To maintain high accuracy, the information utilization part 123 employs an advanced analysis technique such as a deep learning model. For example, a model that is trained using past DSM data is utilized to estimate height information of objects, and the height information is incorporated into analysis results. This approach significantly increases the reliability of data.

Lastly, the information utilization part 123 transmits calculated height values to the object segmentation module 110 and the final segmentation module 130. This data flow makes object detection and segmentation results more precise and ultimately enhances the overall performance of the system.

### Method of Giving Corresponding Height to Each Object by Information Utilization Part 123

The information utilization part 123 serves to give an accurate height to each object by utilizing latest DSM data. This process has been designed to set the heights of objects on the basis of the reliability of DSM data and complement object segmentation results. For example, individual heights may be given to urban objects, such as buildings, roads, vegetation, and the like, on the basis of latest DSM data.

In the first operation, the height value of each object is initialized on the basis of the DSM data. The information utilization part 123 initializes the height of an object by referring to each pixel value of the DSM data. For example, when a DSM pixel value of an area classified as a building object is 30 meters, the initial height of the building is set to 30 meters. This operation is a basic task for reflecting the reliability of DSM data without any change.

In the second operation, it is verified whether the boundaries of objects correspond to the DSM data. The information utilization part 123 analyzes whether the object segmentation results accurately correspond to the DSM data. For example, when the boundary of a building object does not correspond to a height-changing area of the DSM data, the boundary data is adjusted, or the height value is corrected. This process contributes to improving the accuracy of data.

In the third operation, the average height of objects is calculated. A DSM pixel value in each object is analyzed to calculate the average height, which is given as a representative height of the object. For example, when an area classified as a tree object has DSM pixel values of 10 to 15 meters, the height of the tree object is set to the average, 12.5 meters. This approach may comprehensively reflect height changes in the object.

In the fourth operation, spatial features of height values are reflected. The information utilization part 123 adjusts the heights in consideration of the locations and surroundings of objects. For example, when a building object is in a mountainous region, a reference altitude value of the DSM data is added to set a final height. This makes it possible to accurately show an actual height using terrain features.

In the fifth operation, outliers of the height values are identified and corrected. The information utilization part 123 identifies abnormally high or low values of the object height values and replaces them with surrounding pixel values or an average value. For example, when an abnormal value, such as 50 meters, is given to a road object, the abnormal value is corrected by applying the average height value (e.g., 0 meters) of nearby roads.

In the sixth operation, the height values are subdivided on the basis of detailed classifications of objects. The information utilization part 123 adjusts the heights of even the same type of objects in accordance with their detailed classifications. For example, among building objects, residential buildings and commercial buildings may have different heights. In this case, the DSM data may be combined with the detailed classifications of objects to give each object a height.

Lastly, the results of giving heights are visualized and stored. The information utilization part 123 visualizes objects as 3D models on the basis of given heights and provides the 3D models to the user. For example, the heights of building objects may be expressed as 3D models to visually show the spatial structure of an overall city. The given height data is stored in the database and then reutilized in an analysis or training process.

The process of giving heights by the information utilization part 123 provides a reliable height to each object using the latest DMS data and plays an important role in increasing the accuracy of object detection and segmentation. This process can be utilized in various industrial fields and contributes to generating practical analysis results while maintaining data quality.

### Detailed Configuration and Role of Final Segmentation Module 130

The final segmentation module 130 serves to generate final object detection and segmentation results by combining data generated by the object segmentation module 110 and the height estimation module 120. This module derives more precise results by analyzing pixel data and height data of objects in an integrative manner. For example, objects identified from the orthophoto data are combined with height data to clearly distinguish buildings, roads, vegetation, and the like.

The final segmentation module 130 generates final land cover data and land use data on the basis of the combined data. This provides analysis results that not only simply segment objects but also reflect uses and features of the objects. For example, road objects may be utilized for traffic network analysis, and building objects may be utilized in urban planning.

The final segmentation module 130 performs an automatic verification process to maintain data consistency. For example, when the height value of an object does not correspond to a classified object type, the data is reviewed and corrected. This has an important role in ensuring the reliability of analysis results.

The final segmentation module 130 provides data that may be utilized in various industrial fields. For example, data of the final segmentation module 130 is used for identifying flooding-prone regions in disaster management and analyzing the distribution and condition of vegetation in agriculture. These application possibilities show the practical value of the final segmentation module 130.

Finally, the final segmentation module 130 visualizes object detection and segmentation results and intuitively provides the visualized results to the user. For example, the final segmentation module 130 may generate a map in which objects are distinguished by color, or may provide 3D visualized height data. This visualization facilitates data interpretation and helps the user to make a decision.

### Object Segmentation Result Derivation Part 131

The object segmentation result derivation part 131 performs a core function of finally deriving object segmentation results by combining results generated by the object segmentation module 110 and the height estimation module 120. This element integrates pixel-specific object segmentation results with the height information to clearly define the boundary of each object. For example, buildings and vegetation with the same color may be accurately distinguished on the basis of the height information.

The object segmentation result derivation part 131 analyzes not only the boundaries of objects but also internal attributes and incorporates the analysis results into final results. For example, in the case of a road object, the object segmentation result derivation part 131 analyzes not only the boundary but also the width and shape to provide data that may be utilized in traffic analysis. This analysis contributes to increasing the practicality of results.

The object segmentation result derivation part 131 maximizes the accuracy of object segmentation by fusing various data sources. For example, the orthophoto data and the DSM data are simultaneously utilized to combine spatial features and height features of objects. This data fusion solves the problem of data sparsity in different environments and generates accurate analysis results.

The object segmentation result derivation part 131 performs a real-time verification and correction task to increase the precision of data. For example, when the height value of an object in analysis results is abnormal, the data is reviewed, and accurate data is generated. This real-time correction function has an important role in ensuring the reliability of analysis results.

Finally, the object segmentation result derivation part 131 transmits derived results to the final object-type output part 132 of the final segmentation module 130 to facilitate a follow-up task. This data flow makes the object detection and segmentation task more efficient and enhances the overall performance of the system.

### Method of Outputting Object Segmentation Results by Object Segmentation Result Derivation Part 131

The object segmentation result derivation part 131 serves to finally output object segmentation results by combining data generated by the object segmentation module 110 and the height estimation module 120. This process focuses on providing results that may be easily understood and utilized by users through data integration, verification, and visualization. For example, the object segmentation result derivation part 131 may separate road, building, and vegetation objects by analyzing orthophoto data of an urban region and output results including the height information of the objects.

In the first operation, object boundary and height information is integrated. The object segmentation result derivation part 131 integrates pixel-specific object segmentation data with the height information to clearly define the boundary of each object and give a height value to each object. For example, road objects may be expressed as a flat area, and building objects may be expressed in colors gradually changing in accordance with heights. This operation makes distinction between objects clearer.

In the second operation, object attribute information is additionally analyzed. The object segmentation result derivation part 131 calculates additional attributes, such as areas, boundary lengths, central points, and the like, of objects and includes the additional attributes in output results. For example, a building object with an area of 100m² or more may be classified as a commercial building and included in the visualization results. This additional information increases the utilization of results.

In the third operation, the object segmentation results are visualized. The object segmentation result derivation part 131 distinguishes objects by color and visually expresses the objects. For example, a result may be generated in the form of a map with buildings in blue, roads in red, and vegetation in green. This visualization helps the user to intuitively understand the structure of data.

In the fourth operation, relationships between objects are analyzed, and objects are expressed in combination. The object segmentation result derivation part 131 analyzes spatial relationships between objects and incorporates the analysis results into output results. For example, the connections between roads and buildings may be visually expressed to analyze urban transportation networks. This expression of relationships increases the applicability of the results.

In the fifth operation, the results are verified for precision and corrected. The object segmentation result derivation part 131 verifies whether the segmentation results correspond to actual data and performs a correction task as necessary. For example, when an area in which a road object overlaps a building object is detected, this is corrected to update the results. This process increases the reliability of output results.

In the sixth operation, the results are provided in various forms. The object segmentation result derivation part 131 may output the results in the form of an image, a data file, or a 3D model. For example, the results may be stored in the form of a GeoTIFF file and utilized in a geographic information system (GIS) application program or may be output as a 3D model and used in an urban design tool. This flexibility contributes to expanding the range of result utilization.

Lastly, the result data is stored in the database and shared. The object segmentation result derivation part 131 stores the generated data in the database such that the data may be reused thereafter in an analysis or training program or another application program. For example, the stored results may be utilized as model training data by the additional training part 133 or reference data for analyzing another region.

This method of outputting object segmentation results plays an important role in increasing the visual intuitiveness and the reusability of data and providing high-quality data that may be utilized in various application fields. This process supports effective interactions between the user and the system and maximizes the value of the overall analysis system.

### Final Object-Type Output Part 132

The final object-type output part 132 serves to determine final types of objects on the basis of data received from the object segmentation result derivation part 131 and output the final type of objects. This element comparatively analyzes a height value and classification information given to each object and finally determines the type of object. For example, an object with a certain height or more is classified as a building, and an object with less than the certain height is classified as a road.

The final object-type output part 132 precisely analyzes attributes of each object to minimize errors. For example, when a height value does not satisfy a certain criterion, the final object-type output part 132 analyzes the data again through the height estimation module 120 and generates accurate results. This process contributes to increasing the reliability of object classification.

The final object-type output part 132 visually expresses object types to facilitate understanding by the user. For example, each object may be given a color or visualized as a 3D model such that the user may intuitively check object classification results. This plays an important role in utilizing analysis results.

The final object-type output part 132 classifies data by the use of each object such that the classified data may be utilized in various application fields. For example, building data may be utilized in urban planning, and road data may be utilized in traffic analysis. These application possibilities prove the substantial value of the system.

Lastly, the final object-type output part 132 stores analysis results in the database or transmits the analysis results to an external system such that a follow-up task may be performed. For example, additional training or simulation may be performed on the basis of the analyzed data. This function contributes to increasing the scalability of the system.

### Method of Outputting Final Object Types by Final Object-Type Output Part 132

The final object-type output part 132 serves to finally determine the type of each object by utilizing the data generated by the object segmentation result derivation part 131 and the height estimation module 120 and output the type of object. This process focuses on determining a final classification on the basis of attributes of each object and visually expressing the results or storing the results as data such that the user may utilize the results. For example, building, road, and vegetation objects may be finally classified, and results including the height value and attributes of each object may be output.

In the first operation, object attributes are verified, and classification criteria are applied. The final object-type output part 132 reviews attributes of each object and finally classifies the object on the basis of predefined classification criteria. For example, an object with a height of 10 meters or more and an area of 50m² or more is classified as a building, and an object with a small area and a continuous shape is classified as a road. These criteria increase the reliability of classification results by accurately reflecting features of objects.

In the second operation, it is determined whether a height value corresponds to the classification criteria. The final object-type output part 132 reclassifies or corrects an object of which a height value does not corresponds to the classification criteria. For example, when an object with a height value of less than 1 meter is classified as a building, the object is reclassified as a road or vegetation object. This process contributes to maintaining the consistency of data and preventing incorrect classification.

In the third operation, the final types of classified objects are visually expressed. The final object-type output part 132 distinctively visualizes the classified objects using colors, textures, or signs. For example, a map with roads in red, buildings in blue, and vegetation in green may be generated, or the heights and types of objects may be intuitively shown using 3D models. This visualization helps the user to easily understand the results.

In the fourth operation, detailed information of objects is output together. The final object-type output part 132 outputs not only the types of objects but also detailed information such as heights, areas, central point coordinates, and the like. For example, the information “type of building: commercial, height: 15 meters, area: 100m²” may be provided for a building object. This detailed information increases the utilization of results and may be useful in various application fields.

In the fifth operation, a result verification and correction function is provided. When a classification result is incorrect or does not satisfy user-defined criteria, the final object-type output part 132 may support correction. For example, when the user requests that a specific object having been classified as vegetation be reclassified as a building, the final object-type output part 132 incorporates the request into the result, updating the result. This function is useful for improving results on the basis of user feedback.

In the sixth operation, various output formats are supported. The final object-type output part 132 outputs the results in the form of an image, a 3D model, or a data file such that the results may be utilized in various application programs. For example, the results may be output in GeoJSON format and used in a GIS tool or may be output in a 3D CAD format and utilized in urban design software.

Lastly, the result data is stored in the database and shared. The final object-type output part 132 stores the output results in the database such that the results may be utilized in subsequent analysis or training. For example, the stored data may be utilized by the additional training part 133 as training data for the deep learning model or utilized as reference data for another region. This storage and sharing process increases the scalability of the system and ensures long-term data utilization.

This output method of the final object-type output part 132 plays an important role in increasing the reliability of final classification results and maximizing the possibility of the data being utilized. This process provides accurate and practical analysis results in various application fields and supports effective interactions between the user and the system.

### Additional Training Part 133

The additional training part 133 functions to continuously train the system using a rule-based learning or deep learning model on the basis of the object detection and segmentation results. This element adds new data to training data to improve the accuracy of a model and enhance the flexibility of the system. For example, when there is a new type of object that has not been learned, the new type of object may be learned and accurately classified.

The additional training part 133 improves the performance of the model by reutilizing past analysis results. For example, the additional training part 13 enhances the estimation power of the learning model by comparing building data analyzed in the past with current data. This approach makes it possible to effectively handle data that changes over time.

The additional training part 133 increases the adaptability of the system through a real-time learning function. For example, data collected in real time by a drone is analyzed and added to training data to immediately update the model. This makes it possible to maintain high performance even in an emergency situation or a new environment.

The additional training part 133 applies various learning techniques to ensure model diversity. For example, rule-based learning is used to learn unique features of objects, or layers are added to the deep learning model to analyze the complex relationships between objects. This technique contributes to increasing the reliability of analysis results.

Lastly, the additional training part 133 stores training results in the database or transmits the training results to an external system such that continuous improvements may be made. For example, the trained model may be applied to another system, or analysis results may be visualized and provided to the user. This function greatly enhances the scalability and applicability of the system.

### Rule-Based Learning Process of Additional Training Part 133

Rule-based learning is a method of detecting and classifying objects in accordance with rules defined by the user. Through rule-based learning, the additional training part 133 improves the accuracy of object detection and classification. This learning method has been designed to apply specific rules of existing data and generate consistent classification results of new data. For example, the additional training part 133 may utilize rules that buildings in an urban region generally have a quadrangular structure and are highly likely to have a nearby road object.

The first operation of rule-based learning is initial rule defining. The user defines rules on the basis of unique attributes of objects. For example, the user may define the rule “an object with a height of 10 meters or more and an area of 50m² or more is classified as a building.” Such initial rules provide a basic frame for efficiently processing data and are designed to reflect features of a dataset.

The subsequent operation is rule application and data analysis. The additional training part 133 applies the defined rules to existing data to classify objects. For example, orthophoto data and height data of a specific region are analyzed to separate building, road, and vegetation objects. In this process, classification of objects that do not meet rules is postponed or the objects are marked as requiring further analysis.

An important part of rule-based learning is error detection and correction. Since not all objects may be correctly classified on the basis of the initial rules, the additional training part 133 applies the rules and then verifies classification results. For example, when an object classified as a building is actually likely to be vegetation, the system detects this error and allows the user to correct this. This verification process contributes to improving the quality of rules.

Subsequently, the additional training part 133 dynamically updates the rules. On the basis of learning results and verification data, the existing rules are modified, or new rules are added. For example, the rule “a road object has a certain width and is highly likely to include the shadows of nearby vehicles” may be added to increase classification accuracy. Such a dynamic rule update allows the system to effectively operate in a new environment.

According to rule-based learning, correlation analysis is performed between data. For example, from road objects that regularly appear around building objects, a rule for detecting similar patterns in a new region may be generated. Such correlation rules play an important role in understanding not only individual objects but also relationships between objects.

The last operation is result storage and utilization. Final object classification results generated through rule-based learning are stored in the database. This data may be utilized in follow-up learning or analysis. For example, the learned rules may be applied to data of another region and used to classify objects in the same way. Such data utilization contributes to increasing the efficiency and applicability of the system.

Although a rule-based learning process may seem like a simple way to process data on the basis of defined rules, increasingly sophisticated results are generated through error validation, dynamic updates, and correlation analysis. This approach provides reliable classification results even when there is insufficient initial data, and may be useful in various application fields.

Process of Additionally Training Deep Learning Model Layer by Additional Training Part 133

The additional training part 133 serves to improve the object detection and segmentation performance by adding a new layer to the deep learning model. This process has been designed to learn new data patterns and increase the precision of analysis results by expanding the structure of an existing model. For example, while the existing model focuses on separating roads and buildings, a new layer may be added to classify types of buildings (e.g., residential and commercial).

The first operation is model structure analysis and additional layer design. The structure of the existing deep learning model is analyzed, and an appropriate layer is designed to perform a new necessary function. For example, in order for a U-Net model to learn object-specific height information, an additional convolutional layer may be added behind an existing layer. This additional layer is designed to receive height data as an input and learn detailed features of an object.

The next operation is model retraining based on new data. The added layer uses new data to retrain the model. For example, satellite data and reconnaissance satellite data may be used to learn the heights and sizes of buildings, which may be utilized to classify detailed structures of buildings. In this process, training data includes an orthophoto, height information (DSM), object classification results, and the like.

In the deep learning model training process, a transfer learning technique may be utilized. When the existing model has already learned the basic functions of object detection and segmentation, the new layer may focus on learning additional information. For example, existing layers are used to separate roads, buildings, and vegetation, and the added layer is used to learn the detailed types of buildings or the widths of roads. This contributes to increasing a learning rate and reducing necessary computing resources.

While training is in progress, verification and overfitting prevention are important. The additional training part 133 distinguishes between training data and verification data to evaluate the performance of the model and utilizes a normalization or dropout technique to prevent overfitting. For example, the verification data is used in the training process such that the model may not excessively depend on a specific dataset.

When training of the added layer is completed, test data is utilized to evaluate performance. For example, orthophoto data of a new region is used as an input to evaluate how accurately the added layer classifies objects. Results of this process are utilized to evaluate the reliability of the model and make additional adjustments as necessary.

The completed model is applied to actual data and performs result analysis. The additional training part 133 uses the new deep learning model to process actual data and compares classification results with existing results to check performance improvement. For example, the completed model may not only accurately distinguish between roads and buildings but may also accurately determine the number of floors of a building and the type of road use.

Lastly, the trained deep learning model is stored in the database and reused for data of another region or a new project. The stored model is immediately applicable to new orthophoto data and may efficiently perform an object detection and segmentation task. This iterative learning and model improvement process significantly contributes to long-term performance improvement of the system.

The process of additionally training a deep learning model layer is designed to overcome the limitations of an existing model and effectively process new data or complex patterns. This approach shows high performance in various application fields and plays an important role in enhancing the flexibility and scalability of the system.

As described above, the present invention relates to a system for improving the accuracy of object detection and segmentation using orthophoto data and height information, effectively solving several problems of the related art. Particularly, even when DSM data is not present or is outdated, the present invention enables object segmentation with high accuracy, overcoming the limitations of the related art. For example, the related art does not allow object segmentation in a region without DSM data, but the present invention solves this problem by generating alternative data using EO satellite data.

First, the present invention incorporates height information into an object detection and segmentation process, enabling clear distinguishment between objects. According to the related art, objects are simply classified by color and texture, and thus objects with similar visual features, such as buildings and vegetation, are not correctly distinguished. According to the present invention, the height values of each object are calculated by the height estimation module 120 and incorporated into a classification process such that buildings and trees can be correctly distinguished.

Second, the present invention solves problems caused by insufficient data or old-version DSM data. According to the related art, when DSM data is not present or is old, the corresponding region cannot be analyzed, or incorrect results are acquired. According to the present invention, old-version DSM data is merged with reconnaissance satellite data by the parallel output part 122 to generate reliable height information, and the height information is incorporated into object segmentation results to solve the problem of insufficient data.

Third, the present invention focuses on increasing the consistency and accuracy of object segmentation results. According to the related art, simple pixel-based classification often results in unclear object boundaries or internal errors. According to the present invention, the pixel segmentation part 112 and the object-type classification part 113 cooperate to analyze spatial relationships between pixels and correct inconsistent data in classified objects such that more sophisticated results are provided.

Fourth, the present invention enables real-time analysis and data processing and thus has practical effects in various application fields. The related art shows a low data processing rate and is difficult to apply in real time, but according to the present invention, objects can be detected and segmented in real time through an efficient algorithm of the object segmentation module 110 and the height estimation module 120. This supports immediate decision making in disaster management or an emergency rescue operation.

Fifth, the present invention significantly improves the reliability of analysis results by fusing various data sources. The related art depends on a single data source and thus has limitations, while the present invention utilizes all of orthophoto data, DSM data, and reconnaissance satellite data to provide ample information. For example, the connections between roads and buildings may be analyzed to clearly identify an urban transportation network structure.

Lastly, the present invention provides the reusability of data and scalability. Object detection and segmentation results may be utilized as training data through the additional training part 133 to continuously improve the performance of the system. This provides flexibility for adapting to new environments or data and maximizes the possibility of utilization in various industrial fields. Such continuous learning and improvement clearly differentiate the system from static and limited systems of the related art.

Consequently, the present invention effectively solves limitations and problems of the related art and provides accuracy, flexibility, and a real-time processing capability for object detection and segmentation. In this way, the present invention provides practical value in various industrial fields and proposes a new standard for data analysis and utilization.

As described above, the system for implementing an object detection and segmentation model according to the present invention remarkably improves the accuracy of object detection and segmentation using orthophoto data and height information through main elements including an object segmentation module, a height estimation module, and a final segmentation module. Even when DSM data is not present or is outdated, the present invention estimates height information using EO satellite data and incorporates the height information into object detection and segmentation results to overcome the limitations of the related art. In addition, it is possible to clearly distinguish objects, such as buildings, roads, vegetation, and the like, by combining object-specific height values with precise pixel-by-pixel analysis, and increase the reliability and utilization of results through real-time data processing and fusion of various data sources. With this configuration, the present invention solves the problem of data sparsity and enables accurate and efficient object detection and segmentation, thus providing practical value in various application fields such as urban planning, disaster management, environmental analysis, and the like.

In the above detailed description of the present invention, only a specific exemplary embodiment of the present invention has been described. However, it should be understood that the present invention is not limited to the specific form disclosed in the detailed description and rather includes all modifications, equivalents, and substitutions within the spirit and scope of the present invention defined in the appended claims.

In other words, the present invention is not limited to the above specific embodiment and description. Various modifications can be made by those of ordinary skill in the art to which the present invention pertains without departing from the gist of the present invention as claimed, and the modifications fall within the scope of the present invention.

What is claimed is:

1. A system for implementing an object detection and segmentation model, the system comprising:
an object segmentation module (110) configured to accommodate orthophoto data acquired from a satellite and an aerial drone and then segment pixel-specific objects from the accommodated orthophoto data;
a height estimation module (120) configured to calculate a height value of each segmented object in a corresponding region on the basis of an estimated height value which is obtained using digital surface model (DSM) data or electro-optical (EO) satellite data of the corresponding region; and
a final segmentation module (130) configured to output object segmentation result values for final land cover data and final land use data by combining results acquired from the object segmentation module (110) and the height estimation module (120).

2. The system of claim 1, wherein the object segmentation module (110) comprises:
a raw data accommodation part (111) configured to extract orthophoto data acquired from a satellite and an aerial drone regarding the corresponding region designated by a user from an Internet network or a prestored database and store the extracted orthophoto data in a database installed in the system;
a pixel segmentation part (112) configured to classify each pixel as an object in the orthophoto data extracted by the raw data accommodation part (111) and partition an area of each object from an entire area; and
an object-type classification part (113) configured to classify an object of each area partitioned by the pixel segmentation part (112) as a road object, a building object, or a vegetation object.

3. The system of claim 2, wherein the height estimation module (120) comprises:
a height estimation part (121) configured to estimate a height of each object using the EO satellite data of the corresponding region and give an estimated corresponding height to each object when there is no DSM data of the corresponding region designated by the user;
a parallel output part (122) configured to estimate a height of each object using the EO satellite data of the corresponding region and give an estimated corresponding height to each object together with old-version data when the DSM data of the corresponding region designated by the user is the old-version data falling outside a preset tolerance period; and
an information utilization part (123) configured to give a corresponding height to each object using the DSM data of the corresponding region when the DSM data of the corresponding region designated by the user is data falling within the preset tolerance period.

4. The system of claim 3, wherein the final segmentation module (130) comprises:
an object segmentation result derivation part (131) configured to output object segmentation results for final land cover data and final land use data by combining results of the object segmentation module and results of the height estimation module; and
a final object-type output part (132) configured to determine whether a height value given in accordance with an object type satisfies a preset criterion, output a final object type of a corresponding object when the height value given in accordance with the object type satisfies the preset criterion, and give a height value to the corresponding object again through the height estimation module (120) and then output a final object type for the corresponding object when the height value given in accordance with the object type does not satisfy the preset criterion.

5. The system of claim 3, wherein the final segmentation module (130) comprises an additional training part (133) configured to perform rule-based learning on the basis of data acquired through the object segmentation result derivation part (131) and the final object-type output part (132), or add a deep learning model layer, perform training, and then store training results in the database installed in the system.
